(19) United States
(12) Patent Application Publication
(10) Pub. No.: US 2004/0152045 A1
(43) Pub. Date: Aug. 5, 2004

(54) PCD dental drill bit

(76) Inventor: Benjamin Kachalon, Kibbutz Tel Katzir (IL)

Correspondence Address: Dekel Patent Ltd., Beit HaRofim, Room 27, 18 Menuha VeNahala Street, Rehovot, IL

(21) Appl. No.: 10/356,507

(22) Filed: Feb. 3, 2003

(51) Int. Cl. A61C 3/02

(52) U.S. Cl. 433/165

(57) ABSTRACT

A dental drill bit with a tip comprising polycrystalline diamond (PCD), such as a composite of abrasive PCD bonded to a substrate material.

### FIELD OF THE INVENTION

The present invention relates generally to dental drill bits, and more particularly to a polycrystalline diamond (PCD) dental drill bit.

### BACKGROUND OF THE INVENTION

In the medical field generally, and in the dental field specifically, drills or drill bits are provided for drilling holes of a specific size and depth in body tissue such as bone or a tooth to a specified depth. For example, a preliminary step in the installation or placement of a dental implant involves drilling a hole in the jaw to a specified depth. A dental implant may then be installed into the hole.

A dental surgeon or other dental practitioner drilling holes in a patient's jaw must ensure there is minimum risk of infection and damage to the patient, and must often contend with discomfort caused to the patient. Various factors related to the drilling may contribute to or aggravate patient discomfort and pain. Such factors include, without limitation, drill speed, drill diameter and time duration of drilling. Dental drills generally operate at high rotational speeds, which generate heat during the drilling procedure. Various techniques are used to cool the drilling site, such as bathing with cooling liquid, but these techniques are not always sufficient in avoiding damage to tissue surrounding the treatment site. Usually step drilling is necessary, as a desired diameter of a hole cannot be obtained with one drill bit, thereby necessitating drilling a small pilot hole followed by drilling with a larger diameter drill bit until the final required diameter is achieved. The added drilling increases the time duration of drilling, generates more damaging heat, increases risk of infection as more instruments are used and the wound is exposed longer, and adds to patient discomfort.

Diamond-tipped drill bits for dentistry work are known. Diamond drill bits may help solve some of the abovementioned problems due to their extreme hardness. Diamond dental drill bits have been manufactured with a chemical vapor deposited (CVD) diamond film on the drill bit as the cutting element.

### SUMMARY OF THE INVENTION

The present invention seeks to provide a novel dental drill bit, which is a polycrystalline diamond (PCD) dental drill bit, as is described more in detail hereinbelow.

PCD has not heretofore been used for dental drill bits. It is possible that manufacturers have ignored PCD for dentistry work because CVD diamond film may have been considered harder than PCD, and that binders used for PCD may have been considered to degrade the performance of the tool in terms of increased friction, reduced chemical and thermal stability, and possible contamination of the drilling site. However, it has been found in testing that the PCD dental drill bit of the present invention does not have any of these disadvantages and on the contrary provides superior drilling performance as compared to CVD diamond-tipped dental drill bits.

It has been further found in testing that the PCD dental drill bit of the present invention may be used to drill relatively large diameter holes that heretofore could only be drilled by first drilling a small pilot hole and then drilling with larger diameter drill bits.

There is thus provided in accordance with an embodiment of the present invention apparatus comprising a dental drill bit with a tip comprising polycrystalline diamond (PCD), such as a composite of abrasive PCD bonded to a substrate material. The substrate material may comprise a cemented carbide, e.g., tungsten carbide.

In accordance with an embodiment of the present invention the drill bit comprises a body extending from a rear shank, and the composite of PCD and the substrate material is affixed to the body, such as by brazing with a brazing material with an induction heater or a torch. Silver may be used as the brazing material.

Further in accordance with an embodiment of the present invention the composite of PCD and the substrate material may also include one or more transitional layers comprising a powdered mixture.

### BRIEF DESCRIPTION OF THE DRAWINGS

The present invention will be understood and appreciated more fully from the following detailed description, taken in conjunction with the drawings in which:

FIGS. 1 and 2 are simplified top and side-view illustrations, respectively, of a PCD dental drill bit, constructed and operative in accordance with an embodiment of the present invention; and

FIG. 3 is a simplified sectional illustration of a tip of the dental drill bit of FIGS. 1 and 2.

### DETAILED DESCRIPTION OF PREFERRED EMBODIMENTS

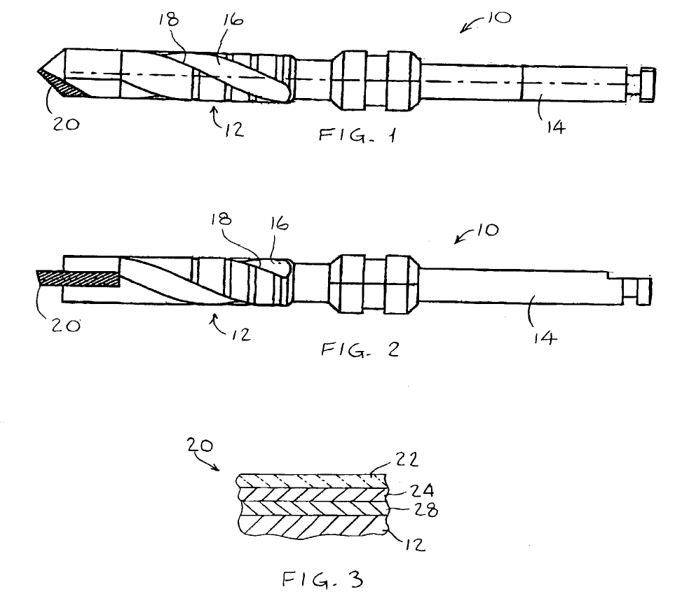

Reference is now made to FIGS. 1 and 2, which illustrate a polycrystalline diamond (PCD) dental drill bit 10, constructed and operative in accordance with an embodiment of the present invention. Drill bit 10 may be used to drill holes for installing therein dental implants.

Drill bit 10 may include a body 12 extending from a rear shank 14. Body 12 may comprise a twisted construction, comprising lands 16 and flutes 18. Body 12 and shank 14 may be constructed of a suitable autoclavable metal, such as but not limited to, tool steel or stainless steel (for example, an austenitic stainless steel, e.g., AISI 305).

Referring additionally to FIG. 3, drill bit 10 may include a tip 20 comprising a cluster or composite (the terms being used interchangeably) of abrasive PCD 22 bonded to a substrate material 24, such as but not limited to, cemented tungsten carbide or boron carbide. It is noted that cemented carbide may be formed from a powdered form of a refractory carbide, which is united by compression with a bonding material (usually iron, nickel, or cobalt), followed by sintering. For example, tungsten carbide may be bonded with 3 to 25 percent cobalt at 1400° C. PCD 22 may be bonded to substrate material 24 at high temperatures and high pressures, which are optimally chosen for the particular carbide and PCD.

The composite of PCD 22 and substrate material 24 may be affixed to body 12, such as but not limited to, by brazing with a brazing material 26. The brazing may be carried out in a variety of manners, such as but not limited to, with an induction heater or torch, with silver as the brazing material 26. The composite of PCD 22 and substrate material 24 may also include one or more transitional layers 28 comprising a powdered mixture with various percentages of diamond, tungsten carbide, and cobalt or other materials. Transitional layers 28 may help reduce thermally induced stresses, which may be caused by differences in thermal expansion.

Drill bit 10 may be constructed in any size or shape used in dentistry, such as but not limited to, conical, egg-shaped, pointed, pear, flame, bullet or spade or any other shape.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. Apparatus comprising:
a dental drill bit with a tip comprising polycrystalline diamond (PCD).

2. The apparatus according to claim 1, wherein said tip comprises a composite of abrasive PCD bonded to a substrate material.

3. The apparatus according to claim 2, wherein said substrate material comprises a cemented carbide.

4. The apparatus according to claim 3, wherein said cemented carbide comprises tungsten carbide.

5. The apparatus according to claim 2, wherein said dental drill bit comprises a body extending from a rear shank, and said composite of PCD and said substrate material is affixed to said body.

6. The apparatus according to claim 5, wherein said composite of PCD and said substrate material is affixed to said body by brazing with a brazing material.

7. The apparatus according to claim 6, wherein said composite of PCD and said substrate material is brazed to said body with an induction heater.

8. The apparatus according to claim 6, wherein said composite of PCD and said substrate material is brazed to said body with a torch.

9. The apparatus according to claim 6, wherein said composite of PCD and said substrate material is brazed to said body with silver as the brazing material.

10. The apparatus according to claim 2, wherein said composite of PCD and said substrate material further comprises at least one transitional layer comprising a powdered mixture.
